(19) United States
(12) Patent Application Publication
(10) Pub. No.: US 2013/0063768 A1
(43) Pub. Date: Mar. 14, 2013

(54) Automated Least Cost Facsimile Routing

(71) Applicant: David Berke, London (GB)

(72) Inventor: David Berke, London (GB)

(73) Assignee: Xerox Corporation, Norwalk, CT (US)

(21) Appl. No.: 13/230,826

(22) Filed: Sep. 12, 2011

(51) Int. Cl. H04N 1/00; H04M 11/00

(52) U.S. Cl. 358/1.15; 379/100.01

(57) ABSTRACT

The present specification discloses devices for faxing documents. In an exemplary embodiment, the device has at least one processor in data communication with a memory, a memory for storing programmatic instructions, where, upon execution by the processor, the programmatic instructions: 1) cause a display to show at least one data field, 2) receive alphanumeric strings that have been inputted into the at least one data field, 3) analyze at least one of the alphanumeric strings, 4) based on the analysis, determine a code, and 5) dial the code prior to dialing any portion of the alphanumeric strings.

### FIELD

The present application discloses telephone number verification methods. More particularly, the present application describes methods for verification of telephone number(s) associated with a facsimile machine having one or more facsimile lines and resolving errors with respect to the same.

### BACKGROUND

Faxing documents is quite ubiquitous and part of the day-to-day work activities of modern organizations. In many organizations, faxes are may be sent to both local and overseas destinations. However, the organizations' service plans with telecommunications providers may not provide for optimum calling rates for all types of phone calls. For example, telecommunication provider A may provide the cheapest calling rates for local calls but relatively expensive rates for calls to Europe and Asia. Telecommunication provider B may provide the cheapest calling rates for Europe but more expensive rates for local calls and calls to Asia. Telecommunication provider C may provide the cheapest calling rates for Asia but more expensive rates for local calls and calls to Europe. Therefore, the conventional approach to faxing, in which an organization relies on a single predefined telecommunications provider to service all fax lines and therefore to transmit all faxes, has distinct disadvantages.

Special calling numbers are available which, if inputted by a user into a fax system, enable a call to be routed through a low cost telecommunications provider. However, such numbers typically comprise a long string of alphanumeric characters, which a user must remember and input into a facsimile system as part of the number to be called. Additionally, if the calling number requires certain additional inputs to be made, such as in response to prompts, existing systems do not provide for a simple way of managing such complexity. Furthermore, an organization may require special numbers to be input into the system, depending on the different destinations being called. Again, existing systems do not provide for a simple way of managing such complexity.

Systems and methods have been disclosed in prior art wherein an additional external hardware device interrupts an outgoing call from a telephone or fax machine to determine the type of call and then re-route the call to achieve a best call rate. Following are examples of such prior art.

U.S. Pat. No. 5,638,433 to Bubien, Jr., et al discloses “an automated transparent programmable telecommunication access call facilitator and dialing memory device for use by connection to a consumer telephone, fax or modem system which electronically, via outside data input, stores a combination of access codes, sequence of numbers and determined data transmission to facilitate user subscribership interconnected grouped discount least cost routing call completion that has been predetermined and automatically updated to offer subscribers the optimum quality and realized group discount cost for the service that is provided through the invention. When a call is initiated, the device uses the consumer dialed number transmitted from the telephone, fax or modem system to retrieve from the memory bank the appropriate one or more choices for use of access code, sequence of numbers and determined data transmission to facilitate user subscribership interconnected grouped discount least cost routing call completion in conjunction with the consumer dialed number and transmits both over the telephone line so that the subscribers call is automatically connected to the subscribers calling destination via the telecommunication company or choice for connection as determined by the provided service and as facilitated by the invention. This least cost routing device functions in a hands free and transparent manner with no effort or choice for call routing decisions having to be made on the part of the user of the invention.”

U.S. Pat. No. 6,075,849 to Lee, et al discloses “a method of monitoring a data transmission transmitted over a telephone line includes the first step of determining if a data transmission is incoming or outgoing over a telephone line. In the second method step, a modem is configured to monitor a receive portion of the telephone line if the first step determines that the transmission is outgoing. The modem is configured to monitor a transmit portion of the telephone line if the first step determines that the transmission is incoming. In the third method step, a data signal is detected from the data transmission. The method may include the further step of maintaining statistics corresponding to the data signal. The data transmission may be a facsimile transmission. The data signal may be any one of a DCS signal, an MCF signal, and an RTP signal.”

Accordingly, there is need for a method and system that reduces fax costs for organizations that fax documents to multiple destinations, including a mix of local and international destinations. There is also need to eliminate use of any additional hardware device (external to the fax machine from which a call is originating) to interrupt an outbound fax call number for re-routing. There is further need for a method and system that enables user programmable/customizable automatic fax call number analyses and re-routing decision prior to a fax call being outputted onto a telephone line.

### SUMMARY

In one embodiment, the present specification discloses a fax machine system comprising at least one processor in data communication with a memory; a memory for storing a plurality of programmatic instructions, wherein, upon execution by the at least one processor, said programmatic instructions 1) cause a display to show a data field, 2) receive an alphanumeric string that has been inputted into said data field, 3) store said alphanumeric string into said memory, 4) parse said alphanumeric string in accordance with a predefined parsing format, 5) based on said parsing, derive a plurality of alphanumeric characters and compare said derived alphanumeric characters to a database; 6) based on said comparison, retrieve a code; and 7) dial said code prior to dialing a portion of said alphanumeric string.

Optionally, the alphanumeric string is a fax number corresponding to a recipient of a fax. The derived alphanumeric character corresponds to a country code. The predefined parsing format is programmed by a user into said system. The predefined parsing format is programmed by accessing an interface that is stored within said memory of the fax machine. The predefined parsing format is programmed by accessing an interface that is stored within a memory that is located remote from the fax machine. The database is stored within said memory of the fax machine and/or in a memory that is located remote from the fax machine. The code is dialed prior to dialing any portion of said alphanumeric string.

In another embodiment, the present specification discloses a device for faxing documents comprising at least one processor in data communication with a memory; a memory for storing a plurality of programmatic instructions, wherein, upon execution by the at least one processor, said programmatic instructions 1) cause a display to show two or more data fields, 2) receive alphanumeric strings that have been inputted into said two or more data fields, 3) analyze at least one of said alphanumeric strings, 4) based on said analysis, determine a code, and 5) dial said code prior to dialing a portion of said alphanumeric strings.

Optionally, at least one of the alphanumeric strings is a fax number corresponding to a recipient of a fax. The analysis determines a country code and, based on said country code, determines the code. The analysis applies a predefined parsing format to at least one of said alphanumeric strings; based on said predefined parsing format, determines a country code; and based on said country code, determines the code. The predefined parsing format is programmed by accessing an interface that is stored within said memory of the fax machine. The predefined parsing format is programmed by accessing an interface that is stored within a memory that is located remote from the fax machine. The analysis determines a country code; compares said country code to a database; and based on said country code, determines the code. The database is stored within said memory of the fax machine. The database is stored in a memory that is located remote from the fax machine. The code is dialed prior to dialing any portion of said alphanumeric strings.

The aforementioned and other embodiments of the present shall be described in greater depth in the drawings and detailed description provided below.

### BRIEF DESCRIPTION OF THE DRAWINGS

These and other features and advantages of the present specification will be further appreciated, as they become better understood by reference to the detailed description when considered in connection with the accompanying drawings, wherein:

FIG. 1 is a block diagram of a fax cost optimization system in accordance with an embodiment of the present specification;

FIG. 2A shows an example of ‘access number’ related data from a telecommunications service provider;

FIG. 2B shows an example dataset of standard country calling codes;

FIG. 2C shows a list of North American numbering plan area codes;

FIG. 3 shows a telephone number dialing pattern for the North American public switched telephone network (PSTN) being accessed from India;

FIG. 4 shows a flow diagram of exemplary steps of the fax cost optimization method in accordance with an embodiment of the present specification;

FIG. 5A shows a data table depicting an exemplary dialing pattern administration; and

FIG. 5B shows a data table depicting an exemplary country calling code and access number administration.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present specification is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the specification.

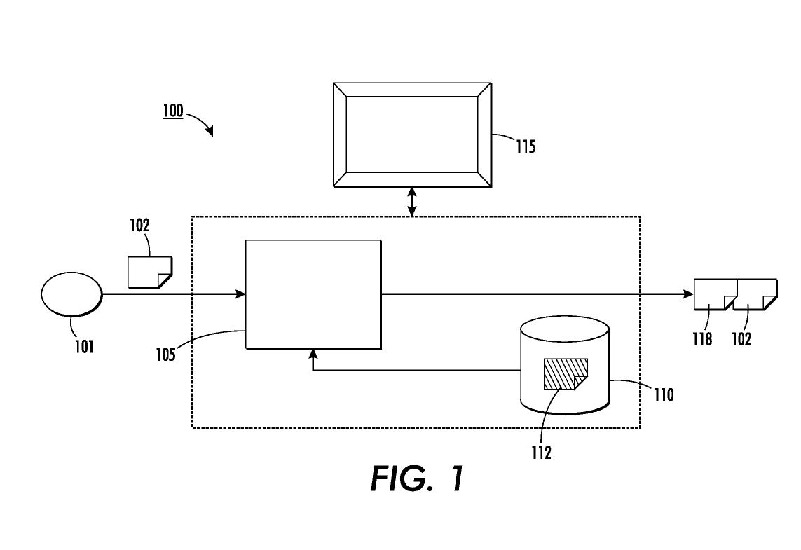

FIG. 1 is a block diagram of a fax cost optimization system 100, in accordance with one embodiment. The system 100 comprises a module 105 in communication with a database 110. In one embodiment, the module 105 is implemented as a set of programmable instructions, such as a software application, which is stored in the memory of a typical facsimile device or a multi-functional device, such as one that combines any or all of the functions of photocopying, scanning, faxing and/or printing. It may be noted that the word “facsimile”, “system”, or “fax machine” as used herein encompasses any apparatus or multi-function device which performs facsimile transmission functions, including but not limited to a standalone fax machine, a machine that combines printing, scanning, and/or faxing functionality, any computer executing software for faxing documents through a communication network, or any handheld device executing software for faxing documents through a communication network.

The module 105 and the database 110 are programmable through an integrated Graphical User Interface (GUI) 115. Persons of ordinary skill in the art should appreciate that in alternate embodiments, the GUI 115 could be implemented as two distinct interfaces: a first interface that is used to program the module 105 and a second interface that is used to program the database 110. In one embodiment, the GUI 115 is a local interface available directly on the fax device or the multi-functional device and/or a web-based interface that is accessible remotely through the Internet.

In one embodiment, the database 110 comprises information 112 related to international calling access numbers from a plurality of third party telecom/carrier companies that offer switching or re-routing services to enable users to make low cost international calls. Additionally, information 112 also comprises data related to global telephone numbering plans as defined by ITU-T recommendations E.123 and E.164. For example, the E.164 numbering plan for telephone numbers comprises country calling codes (also called ISD codes); regional numbering plans, such as the European Telephony Numbering Space, the North American Numbering Plan, among other data, and various national numbering plans, such as the telephone numbers in the UK. In one embodiment, information 112 comprises at least a call destination; telephone numbering plan (that includes at least the ISD country calling code followed by an area code/regional numbering plan) associated with the call destination; an access number for the destination; and the low cost rate (in, for example, price per minute) that would be charged for using the access number for the destination.

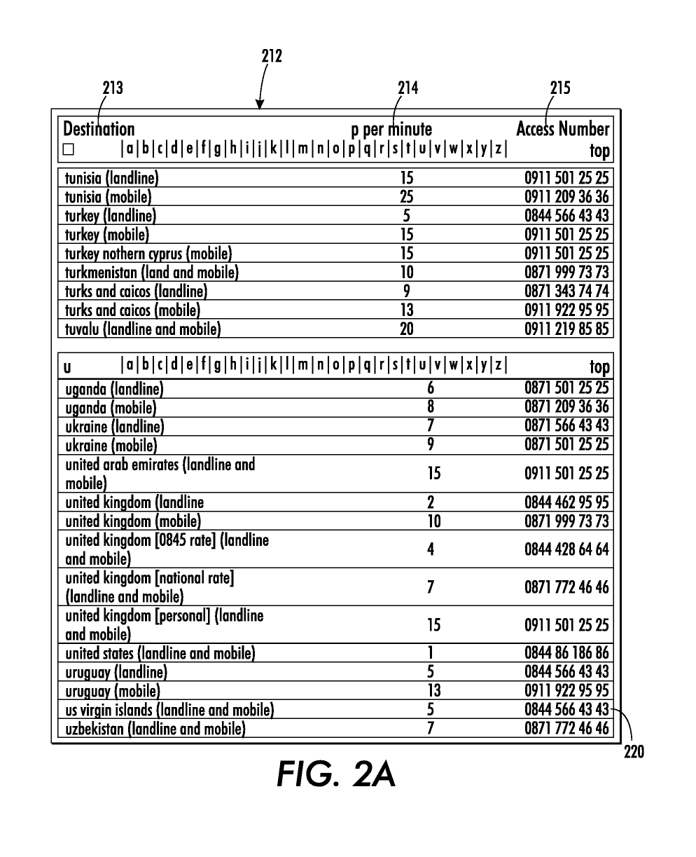

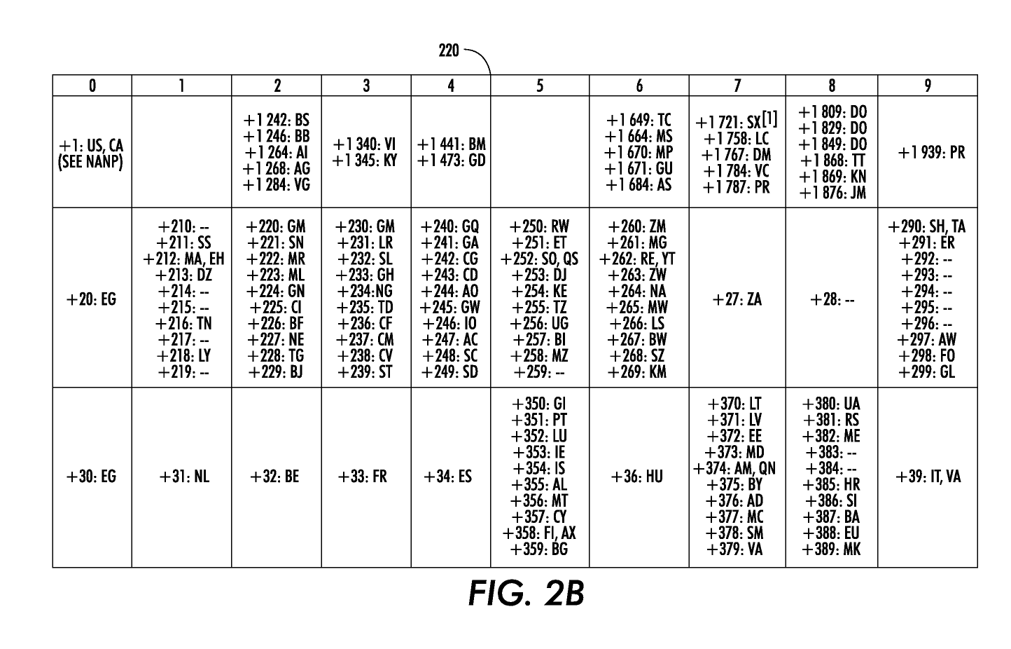

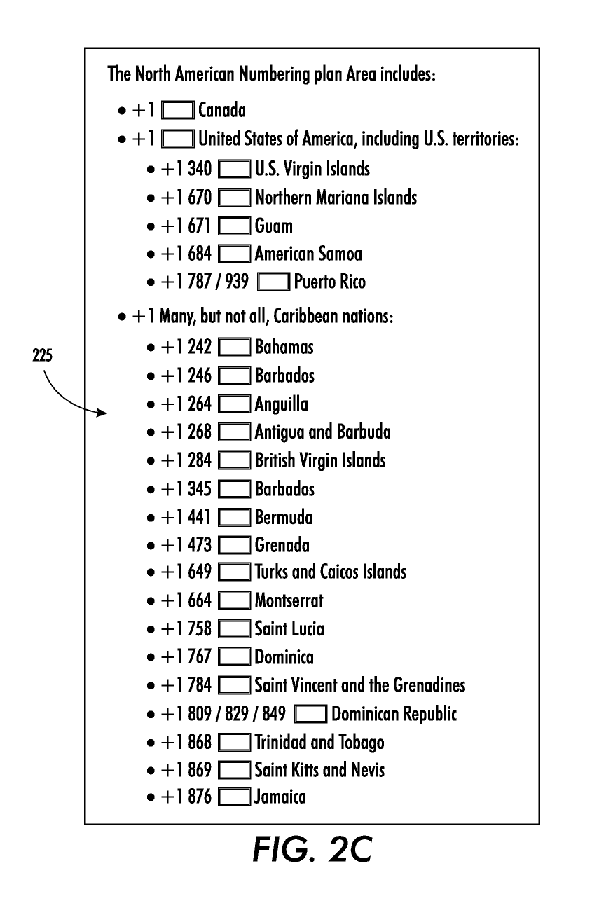

FIG. 2A shows an example of access number related data 212 from a telecommunications service provider comprising destination 213, rate 214 and access number 215 to be used for the destination. FIG. 2B shows, as an example, a partial dataset comprising standard country calling codes 220 defined by the ITU-T recommendations E.123 and E.164. FIG. 2C shows a list of North American numbering plan area codes 225, as an example of a regional numbering plan. In one embodiment, the access number data 212, the country calling codes 220 and the area codes 225 are stored in the form of a relational database and together constitute information 112 of FIG. 1.

Referring back to FIG. 1, the GUI 115 enables users, such as an administrator, to update as well as program information 112 in the database 110. While in a preferred embodiment, the database 110 is located locally within the facsimile or multi-functional device (such as, for example, on a hard disk), persons of ordinary skill in the art should appreciate that in alternate embodiments the database 110 and the facsimile device could be remote and in communication through wired or wireless connection over public (such as the Internet) or private (such as VPN) networks. In one embodiment, the least cost processing methods disclosed herein are implemented by programmatic code stored in a memory local to a fax machine or multi-function device that are executed by at least one processor therein.

In accordance with an embodiment of the present specification, the module 105 implements a method to parse and/or analyze the number 102 inputted into the system by the user 101. Based on the analysis, the system identifies the destination of the fax and automatically routes or switches the call through the access number 118 associated with the identified destination, which is provided by a third party telecommunications company and stored as information 112 in the database 110, to ensure the best cost call rate for the destination would be applied to the call.

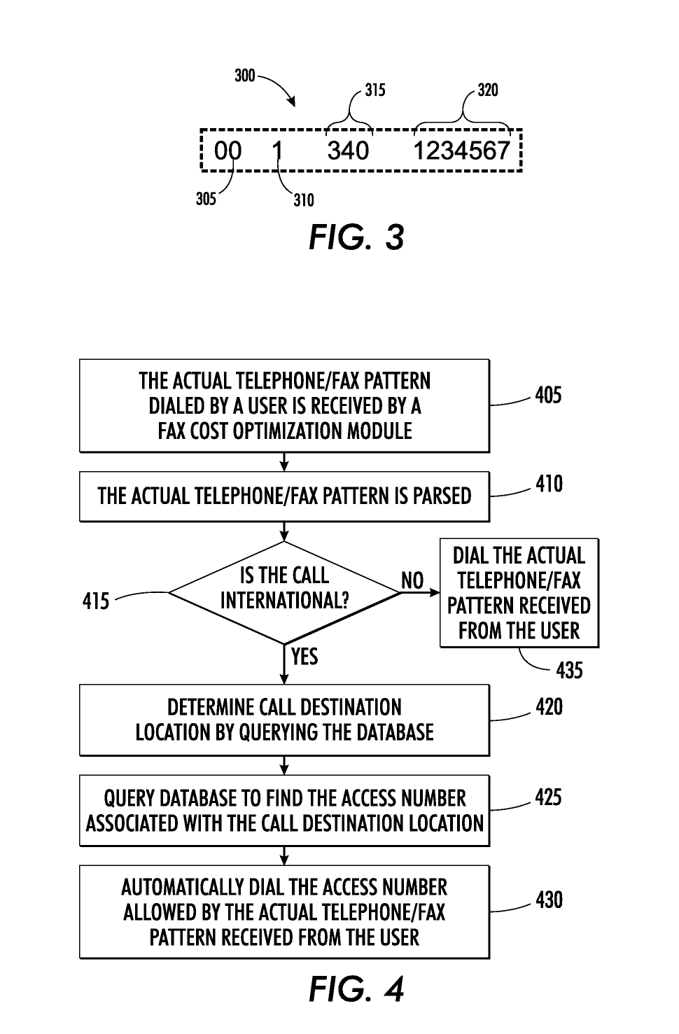

Persons of ordinary skill in the art would appreciate that a telephone numbering plan (defined by ITU-T recommendations E.123 and E.164) establishes the pattern of digits for a telephone number. The pattern typically comprises the country calling code, area code followed by a combination of digits (as the telephone number). An international dialing prefix, such as “00”, is also added before the country calling code when calling from a location outside the country of call destination. As an example, the North American public switched telephone network (PSTN) uses a 10-digit dial plan that includes a 3-digit area code and a 7-digit telephone number, while the country calling code for the US is “1”. Therefore, a dialer from India, when calling a number in the US Virgin Islands, would dial a pattern 300 as shown in FIG. 3. It should be appreciated that “dialing” or “to dial” means, herein, any act of inputting or executing an alphanumeric string associated with another fax machine, whether by a user or machine, to cause the fax machine to initiate a communication connection with the receiving fax machine.

Referring now to FIG. 3, the dialing pattern 300 comprises international dialing prefix 305; the country calling code 310; the area code 315 (for US Virgin Islands) followed by a telephone number 320. To parse or analyze the dialing pattern 300, the module is programmed (using GUI 115 of FIG. 1) in accordance with the following exemplary parsing or analyzing steps:

1. If the first two digits 305 are “00” then it is established that the call is international;

2. The next single digit 310 represents the country calling code. If the country calling code is “1” then it is established by querying and matching with the country calling codes list in the database (110 of FIG. 1) that the call is to be made to the US;

3. The next 3 digits 315 represent the area code. If the area code is “340” then it is established by querying and matching with the area codes list in the database (110 of FIG. 1) that the call is to be made to the US Virgin Islands.

The module queries the database (110 of FIG. 1) to identify the low cost access number associated with US Virgin Islands. As shown in FIG. 2A, the access number 220 associated with US Virgin Islands is “0844 566 43 43” as provided by a third party low cost telecom service provider. Therefore, to optimize the cost associated with faxing/calling internationally, the module enables the facsimile machine dialer to, automatically, first dial the access number associated with US Virgin Islands (to connect to the telecommunications system of the third party low cost telecom service provider), followed by dialing the real telephone pattern, such as pattern 300 of FIG. 3, to finally connect to the destination number. By doing so, the dialer would be charged in accordance with the rate associated with the access number associated with US Virgin Islands and not a higher international call rate from a more expensive telecommunications provider.

Persons of ordinary skill in the art should appreciate that the parsing steps described above are only exemplary and would be programmed or set differently depending upon the location of call origination and destination since the telephone dialing patterns will vary based on call origination and destination locations. For example, in organizations, employees are often required to dial an external line access number, let us say “9”, to get a telephone line that would allow them to call externally to their organization. The parsing steps would, in such case, relate the first numeral of a call pattern to be equivalent to a request to call external to the organization.

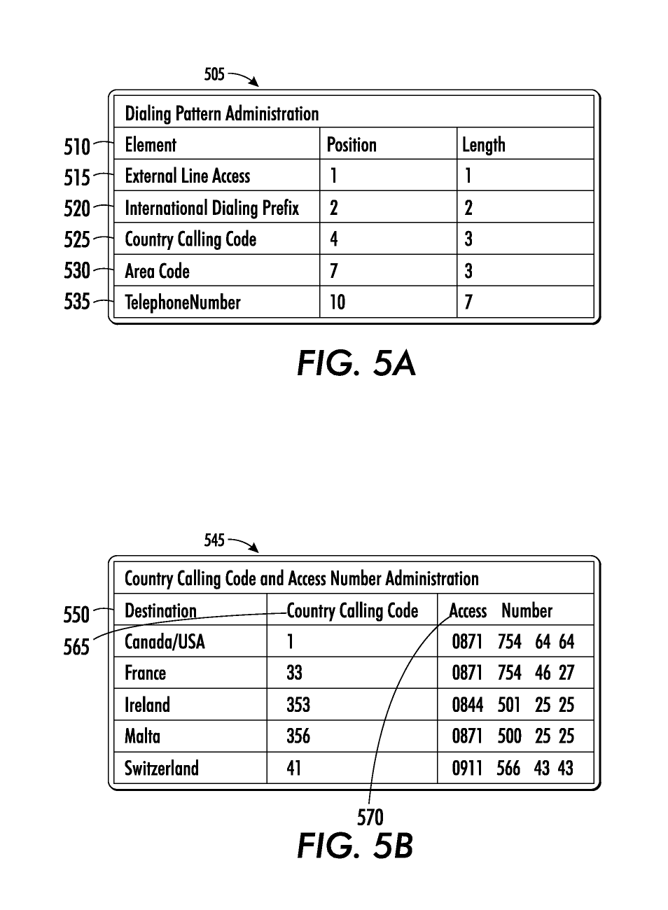

Referring again to FIG. 1, module 105 is programmed to analyze telephone dialing patterns for a plurality of call origination and destination locations around the world. In one embodiment, the module may be programmed through the GUI 115 of FIG. 1. FIG. 5A illustrates an exemplary dialing pattern administration 505, also referred to as a parsing format, enabled by programming via the GUI 115. Since the length of country calling codes for various call originations and destinations vary, in one embodiment, a user may proactively program the parsing process employed by the system to establish the format of inputted phone numbers and, therefore, what inputted data positions correspond to what data element 510.

For example, data corresponding to an external line access number 515 may be located in position 1 and have a length of 1, data corresponding to an international dialing prefix 520 may be located in position 2 and have a length of 2, data corresponding to a country calling code 525 may be located in position 4 and have a length of 3, data corresponding to an area code number 530 may be located in position 7 and have a length of 3, and data corresponding to a telephone number 535 may be located in position 10 and have a length of 7. Each of the data element fields 510 may be allocated different positions, may be allocated different lengths, or may be largely eliminated by setting the length and/or position to 0. By providing this type of programmatic flexibility and versatility, users may tailor the parsing method to their particular faxing environment and minimize the likelihood of parsing errors arising from the inaccurate analysis of inputted numbers. It should further be appreciated that, once programmed, the data element fields may be presented as distinct fields in the GUI, thereby eliminating the need to actively parse an inputted number. Operationally, the GUI would prompt a user for each data element separately and individually, thereby permitting the system to accurately determine exactly what country the user is calling without the need for parsing.

Operationally, once a user programs a specific country calling code length (and subsequently the lengths of the area code and telephone number) and then inputs a number, the system determines the country being called, in real-time, by querying the database 110 and finding a match between the dialed pattern and the stored list of country calling codes, as shown in FIG. 2B. Once the country calling code and therefore the call destination is established, the corresponding access number, as shown in FIG. 2A, is then determined to route the call. FIG. 5B illustrates an exemplary country calling code and access number dataset 545, comprising a plurality of geographic locations, country calling codes, and access numbers, accessible and programmable via the GUI 115. It should be appreciated that, while the geographic locations are shown as being distinct countries, they may include any geographic area, including continents, cities, regions, provinces, states, localities, towns, or other areas.

FIG. 4 shows a flow diagram describing steps of an exemplary fax cost optimization method, in accordance with one embodiment. The module receives 405 the actual telephone/fax pattern dialed by a user. The actual telephone/fax pattern is parsed 410 on the basis of the user-defined parsing steps programmed or set into the module via the GUI described above. In one exemplary parsing step 410, it is first determined 415 if the call is international. If the call is international, then the call destination location is further determined 420 by querying the database and finding a match, for example, for the country and area codes of the call destination. The database is again queried 425 to find the access number associated with the call destination location determined in step 420. The queried access number is automatically dialed 430 first, followed by dialing the actual telephone/fax pattern. If the call is found to be not international at step 415, then the number received from the user (at 405) is dialed 435 as is.

The above examples are merely illustrative of the many applications of the system of present specification. Although only a sampling of embodiments have been described herein, it should be understood that the present specification might be embodied in many other specific forms without departing from the spirit or scope of the inventions. Therefore, the present examples and embodiments are to be considered as illustrative and not restrictive, and the invention may be modified within the scope of the appended claims.

We claim:

1. A fax machine system comprising:
at least one processor in data communication with a memory;
a memory for storing a plurality of programmatic instructions, wherein, upon execution by the at least one processor, said programmatic instructions
cause a display to show a data field;
receive an alphanumeric string that has been inputted into said data field;
store said alphanumeric string into said memory;
parse said alphanumeric string in accordance with a predefined parsing format;
based on said parsing, derive a plurality of alphanumeric characters and compare said derived alphanumeric characters to a database;
based on said comparison, retrieve a code; and
dial said code prior to dialing a portion of said alphanumeric string.

2. The fax machine of claim 1 wherein said alphanumeric string is a fax number corresponding to a recipient of a fax.

3. The fax machine of claim 2 wherein said derived alphanumeric character corresponds to a country code.

4. The fax machine of claim 1 wherein said predefined parsing format is programmed by a user into said system.

5. The fax machine of claim 4 wherein said predefined parsing format is programmed by accessing an interface that is stored within said memory of the fax machine.

6. The fax machine of claim 4 wherein said predefined parsing format is programmed by accessing an interface that is stored within a memory that is located remote from the fax machine.

7. The fax machine of claim 1 wherein said database is stored within said memory of the fax machine.

8. The fax machine of claim 1 wherein said database is stored in a memory that is located remote from the fax machine.

9. The fax machine of claim 1 wherein said code is dialed prior to dialing any portion of said alphanumeric string.

10. A device for faxing documents comprising:
at least one processor in data communication with a memory;
a memory for storing a plurality of programmatic instructions, wherein, upon execution by the at least one processor, said programmatic instructions
cause a display to show two or more data fields;
receive alphanumeric strings that have been inputted into said two or more data fields;
analyze at least one of said alphanumeric strings;
based on said analysis, determine a code; and
dial said code prior to dialing a portion of said alphanumeric strings.

11. The device of claim 10 wherein at least one of said alphanumeric strings is a fax number corresponding to a recipient of a fax.

12. The device of claim 11 wherein said analysis determines a country code and, based on said country code, determines the code.

13. The device of claim 10 wherein said analysis applies a predefined parsing format to at least one of said alphanumeric strings; based on said predefined parsing format, determines a country code; and based on said country code, determines the code.

14. The device of claim 13 wherein said predefined parsing format is programmed by accessing an interface that is stored within said memory of the fax machine.

15. The device of claim 13 wherein said predefined parsing format is programmed by accessing an interface that is stored within a memory that is located remote from the fax machine.

16. The device of claim 10 wherein said analysis determines a country code; compares said country code to a database; and based on said country code, determines the code.

17. The device of claim 16 wherein said database is stored within said memory of the fax machine.

18. The device of claim 16 wherein said database is stored in a memory that is located remote from the fax machine.

19. The device of claim 10 wherein said code is dialed prior to dialing any portion of said alphanumeric strings.
